(19) United States
(12) Patent Application Publication
(10) Pub. No.: US 2026/0304488 A1
(43) Pub. Date: Oct. 1, 2026

(54) RACH POWER CONFIGURATION FOR HIGHER CAPABILITY OR LOW MOBILITY UE

(71) Applicant: QUALCOMM Incorporated, San Diego, CA (US)

(72) Inventors: Navid ABEDINI, Basking Ridge, NJ (US); Tommy AZZINO, Jersey City, NJ (US); Jianghong LUO, Skillman, NJ (US); Mostafa KHOSHNEVISAN, San Diego, CA (US); Junyi LI, Greentown, PA (US); Tao LUO, San Diego, CA (US)

(21) Appl. No.: 19/091,506

(22) Filed: Mar. 26, 2025

(51) Int. Cl. H04W 74/0833; H04W 52/38

(52) U.S. Cl. CPC H04W 74/0833; H04W 52/38

(57) ABSTRACT

Apparatus, methods, and computer program products for wireless communication are provided. An example method may include receiving, from a network node, a first random access channel (RACH) configuration dedicated for a higher capability or low mobility UE type associated with the UE, the first RACH configuration being different from a second RACH configuration for a normal UE. The example method may further include transmitting, to the network node, a RACH transmission based on the first RACH configuration dedicated for the higher capability or low mobility UE type.

### TECHNICAL FIELD

The present disclosure relates generally to communication systems, and more particularly, to wireless communication systems with a random access channel (RACH).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a network node, a first random access channel (RACH) configuration dedicated for a higher capability or a lower mobility UE type associated with the UE, the first RACH configuration being different from a second RACH configuration for a baseline UE. Based at least in part on information stored in the at least one memory, the at least one processor, individually or in any combination, is configured to transmit, to the network node, a RACH transmission based on the first RACH configuration dedicated for the higher capability or the low mobility UE type.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to transmit a first RACH configuration dedicated for a higher capability or a lower mobility UE type associated with the UE and a second RACH configuration for a baseline UE, the first RACH configuration being different from the second RACH configuration. Based at least in part on information stored in the at least one memory, the at least one processor, individually or in any combination, is configured to receive, from a UE, a RACH transmission based on the first RACH configuration dedicated for the higher capability or low mobility UE type.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A is a diagram illustrating a network node in communication with a UE via a set of beams, in accordance with various aspects of the present disclosure.

FIG. 4B and FIG. 4C illustrate example aspects of random access, in accordance with various aspects of the present disclosure.

FIG. 5 is a diagram illustrating example communications between a network entity and a UE, in accordance with various aspects of the present disclosure.

FIG. 6 is a diagram illustrating example communications between a network entity and a UE, in accordance with various aspects of the present disclosure.

FIG. 7 is a flowchart of a method of wireless communication, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a diagram illustrating an example of a hardware implementation for an example apparatus and/or network entity, in accordance with various aspects of the present disclosure.

FIG. 11 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Because higher capability or low mobility user equipment (UE) such as fixed wireless access (FWA) or customer premises equipment (CPE) devices have different characteristics compared to a regular UE, using different (e.g., compared to a regular UE) access procedure for these higher capability or low mobility UE such as CPE or FWA devices may provide a number of different advantages. First, reduction of the signaling/time for each reconnection of these higher capability or low mobility UEs may reduce the associated overhead on the network side (e.g., which may be beneficial when there are many CPEs being deployed and because of their aggregated traffic and a cell may be heavily loaded at times). Second, using different access procedure for these higher capability or low mobility UE such as CPE or FWA devices may speed up the connection for these CPE or FWA devices. Aspects provided herein may provide specific random access channel (RACH) configuration(s) for CPE or FWA devices that may be different from RACH configuration(s) for regular UEs, which may enhance efficiency (e.g., reduction of retransmissions) for CPE or FWA devices, and enhance efficiency for the wireless communication network overall (e.g., based on reduction of load at the cell).

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

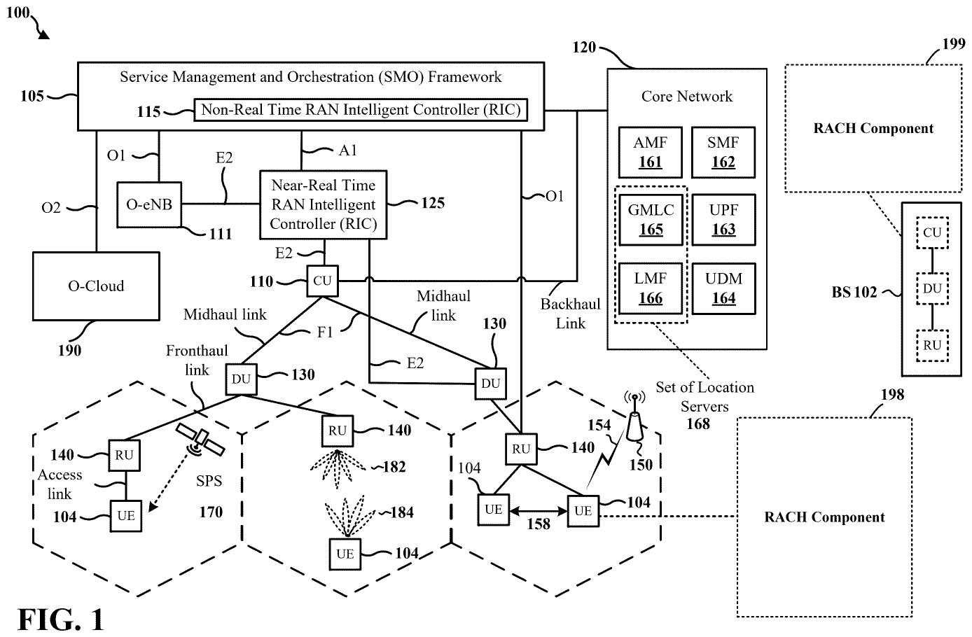

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a RACH component 198. In some aspects, the RACH component 198 may be configured to receive, from a network node, a first RACH configuration dedicated for a higher capability or low mobility UE type associated with the UE, the first RACH configuration being different from a second RACH configuration for a baseline UE (e.g., which may be referred to as a normal UE, a regular UE, a standard UE, or the like). In some aspects, the RACH component 198 may be further configured to transmit, to the network node, a RACH transmission based on the first RACH configuration dedicated for the higher capability or low mobility UE type.

In certain aspects, the base station 102 may include a RACH component 199. In some aspects, the RACH component 199 may be configured to transmit a first RACH configuration dedicated for a higher capability or low mobility UE type associated with the UE and a second RACH configuration for a baseline UE (e.g., which may be referred to as a normal UE, a regular UE, a standard UE, or the like), the first RACH configuration being different from the second RACH configuration. In some aspects, the RACH component 199 may be further configured to receive, from a UE, a RACH transmission based on the first RACH configuration dedicated for the higher capability or low mobility UE type.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

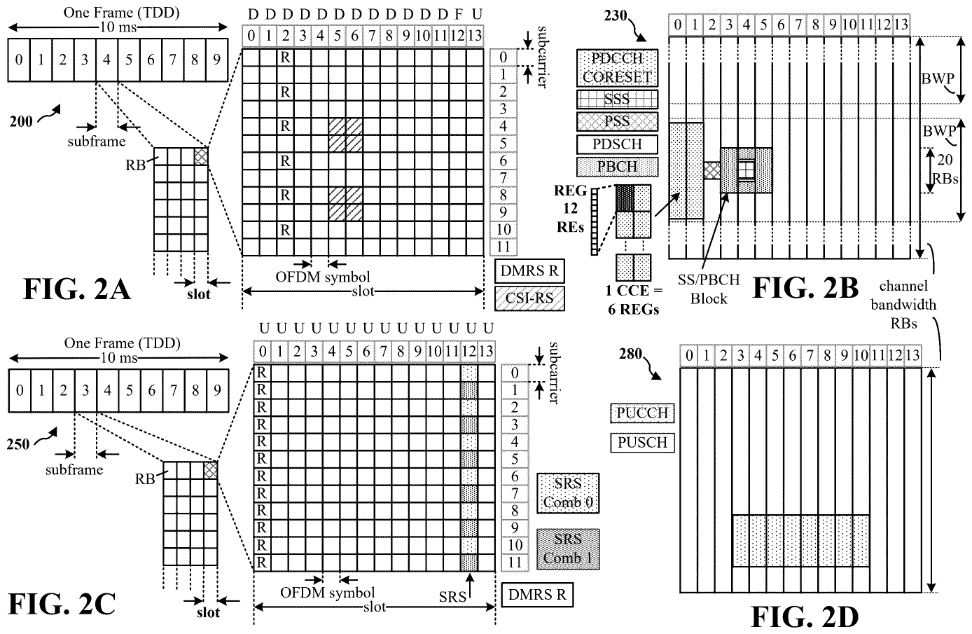

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

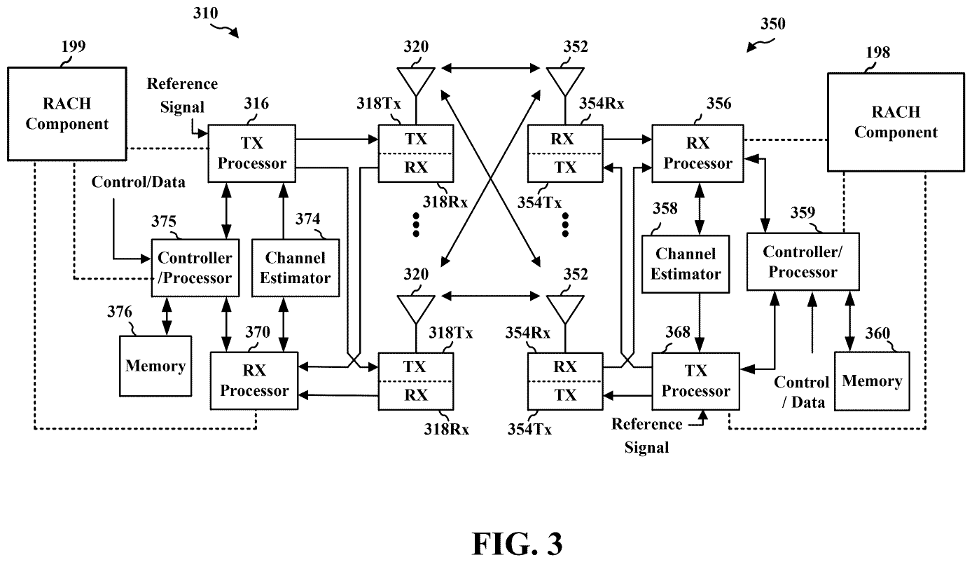

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with RACH component 198 of FIG. 1.

At least one of the TX processor 316, the RX processor 370, and the controller/processor 375 may be configured to perform aspects in connection with RACH component 199 of FIG. 1.

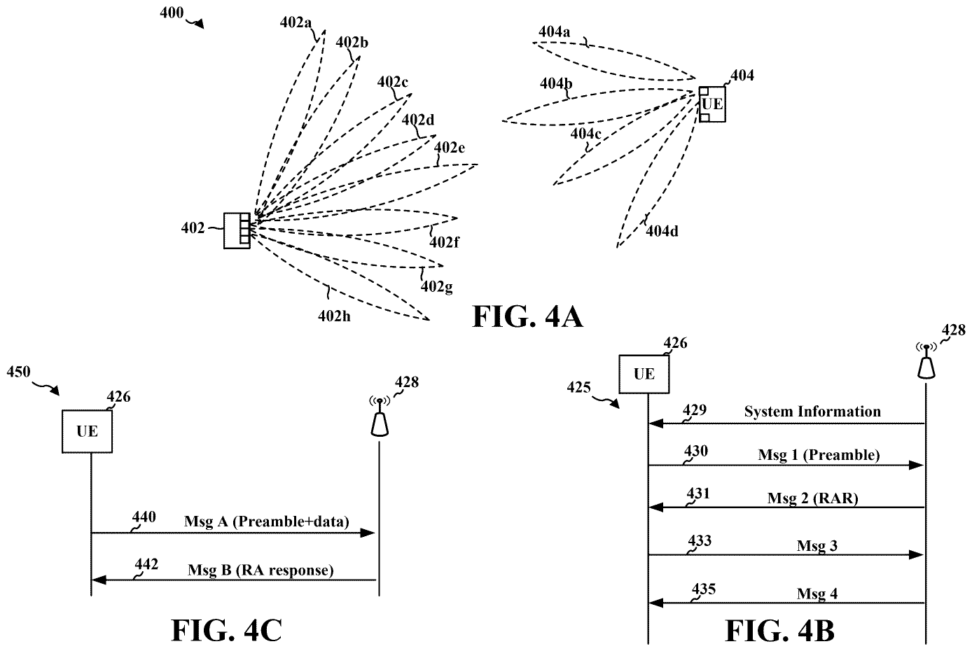

FIG. 4A is a diagram 400 illustrating a network node 402 in communication with a UE 404. Referring to FIG. 4A, the network node 402 may transmit a beamformed signal to the UE 404 in one or more of the directions 402a, 402b, 402c, 402d, 402e, 402f, 402g, 402h. The UE 404 may receive the beamformed signal from the network node 402 in one or more receive directions 404a, 404b, 404c, 404d. The UE 404 may also transmit a beamformed signal to the network node 402 in one or more of the directions 404a-404d. The network node 402 may receive the beamformed signal from the UE 404 in one or more of the receive directions 402a-402h. The network node 402/UE 404 may perform beam training to determine the best receive and transmit directions for each of the network node 402/UE 404. The transmit and receive directions for the network node 402 may or may not be the same. The transmit and receive directions for the UE 404 may or may not be the same. The term beam may be otherwise referred to as “spatial filter.” Beamforming may be otherwise referred to as “spatial filtering.” As used herein, the term “beam” may correspond to “spatial filter.”

In response to different conditions, the UE 404 may determine to switch beams, e.g., between beams 402a-402h. The beam at the UE 404 may be used for reception of downlink communication and/or transmission of uplink communication. In some examples, the network node 402 may send a transmission that triggers a beam switch by the UE 404. A TCI state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a Quasi co-location (QCL) relationship between DL RSs in one RS set and PDSCH/PDCCH DM-RS ports. information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, QCL Type D may indicate a correlation between a spatial parameter (e.g., between directional beams) for a reference signal and another signal to be transmitted or received. For example, a TCI state may indicate a QCL relationship between DL RSs in one RS set and PDSCH/PDCCH DM-RS ports. TCI states can provide information about different beam selections for the UE to use for transmitting/receiving various signals. For example, the network node 402 may indicate a TCI state change, and in response, the UE 404 may switch to a new beam according to the new TCI state indicated by the network node 402.

In some wireless communication systems, such as a wireless communication system under a unified TCI framework, a pool of joint DL/UL TCI states may be used for joint DL/UL TCI state updates for beam indication. For example, the network node 402 may transmit a pool of joint DL/UL TCI states to the UE 404. The UE 404 may determine to switch transmission beams and/or reception beams based on the joint DL/UL TCI states. In some aspects, the TCI state pool for separate DL and UL TCI state updates may be used. In some aspects, the network node 402 may use RRC signaling to configure the TCI state pool. In some aspects, the joint TCI may or may not include UL-specific parameter(s) such as UL PC/timing parameters, PL RS, panel-related indication, or the like. If the joint TCI includes the UL-specific parameter(s), the parameters may be used for the UL transmission of the DL and UL transmissions to which the joint TCI is applied.

As used herein, the term “higher capability or low mobility UE type” refers to a UE that may have a higher capability or have a lower mobility (e.g., stationary, configured to be stationary for a long period of time (e.g., more than one day), or configured to have a movement that is less than a threshold (e.g., within a particular area)) compared to a baseline UE (e.g., which may also be referred to as a “normal UE,” a “regular UE,” or a “standard UE,” or the like). Such UEs may also be referred to as a higher capability UE type, a low mobility UE type, and/or a lower mobility UE type. As an example, the baseline UE may correspond to smartphones, tablets, and mobile broadband devices that support communication via various frequency bands such as FR1 and FR2 and various features including carrier aggregation, MIMO, high modulation schemes such as 256 quadrature amplitude modulation (QAM) and 1024-QAM. The baseline UE may have a higher capability than a reduced capability UE. Examples of higher capability or low mobility UE type may include fixed wireless access (FWA) or customer premises equipment (CPE) devices, for example. FWA devices may be a type of devices that may provide other UEs in an area with Internet access via mobile network based on 5G, 6G, or the like. CPE devices may be a type of devices that may be used by end users to connect to a network provider's fixed wireless service by acting as the receiver for FWA services and include routers, modems, or dedicated outdoor antennas.

Compared to a baseline UE that may move locations often, CPE or FWA devices may be stationary (or may rarely move outside a particular area), such as being mounted on a particular spot. CPE or FWA devices may also be more powerful than a regular UE and may support a higher transmit power in the form of a higher total radiated power (TRP) or a higher effective isotropic radiated power (EIRP). In some aspects, the CPE or FWA device may plug in to a power source, e.g., whereas a regular UE may rely on battery power. The TRP may be the total power radiated by an antenna in all directions and may be calculated based on integrating the power radiated in all directions over a sphere surrounding the antenna. EIRP may be the maximum power that would be radiated by an isotropic antenna (one that radiates equally in all directions) if all power were concentrated in a single direction. Another type of higher capability or low mobility UE may be vehicle UEs.

Because higher capability or low mobility UE such as CPE or FWA devices have different characteristics compared to a baseline UE, using different (e.g., compared to a baseline UE) access procedure for these higher capability or low mobility UE such as CPE or FWA devices may provide a number of different advantages. First, reduction of the signaling/time for each reconnection of these higher capability or low mobility UEs may reduce the associated overhead on the network side (e.g., which may be beneficial when there are many CPEs being deployed and because of their aggregated traffic and a cell may be heavily loaded at times). Second, using different access procedure for these higher capability or low mobility UE such as CPE or FWA devices may speed up the connection for these CPE or FWA devices. Aspects provided herein may provide specific RACH configuration(s) for CPE or FWA devices that may be different from RACH configuration(s) for regular UEs, which may enhance efficiency for CPE or FWA devices, and for the wireless communication network overall. The assess procedure for reduced capability UEs may also be different from the assess procedure of a baseline UE.

In some aspects, to allow for more efficient RACH (e.g., successful RACH without retransmission), more aggressive transmission power may be configured for CPE devices by configuring higher capability or low mobility UE such as CPE or FWA devices with different RACH power configurations. As a particular example, a network node may broadcast, in system information block (SIB) 1 (SIB 1), dedicated RACH configuration(s) for higher capability or low mobility UE such as CPE or FWA devices that may be different from RACH configuration(s) for regular UEs. In some aspects, the network may support configuring dedicated RACH power configuration or RACH resources for CPE devices to allow more flexibility in the choice of various RACH petameters and power configuration.

A UE may use a random access procedure in order to communicate with a base station. For example, the UE may use the random access procedure for various reasons, e.g., including to request an RRC connection, to re-establish an RRC connection, resume an RRC connection, etc. Random access procedures may include two different random access procedures, e.g., The UE may use contention based random access (CBRA) may be performed when a UE is not synchronized with a base station, and the CFRA may be applied, e.g., when the UE was previously synchronized to a network node. Both the procedures include transmission of a random access preamble from the UE to the base station. In CBRA, a UE may randomly select a random access preamble sequence, e.g., from a set of preamble sequences. As the UE randomly selects the preamble sequence, the base station may receive another preamble from a different UE at the same time. Thus, CBRA provides for the base station to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention free” random access. The preamble may be based on a particular preamble format, such as long format for large cell coverage, short format for dense urban areas, or the like.

FIG. 4B illustrates example aspects of a random access procedure 425 between a UE 426 and a network node such as a base station 428. The aspects illustrated for the network node 402 may be performed by one or more components of the base station. The UE 426 may initiate the random access message exchange by sending, to the base station 428, a first random access message 430 (e.g., Msg 1) including a preamble in a random access occasion (RO). Prior to sending the first random access message 430, the UE may obtain random access parameters, e.g., including preamble format parameters, time and frequency resources, parameters for determining root sequences and/or cyclic shifts for a random access preamble, etc., e.g., in system information 429 from the base station 428. The preamble may be transmitted with an identifier, such as a Random Access RNTI (RA-RNTI). The UE 426 may randomly select a random access preamble sequence, e.g., from a set of preamble sequences. If the UE 426 randomly selects the preamble sequence, the base station 428 may receive another preamble from a different UE at the same time. In some examples, a preamble sequence may be assigned to the UE 426.

The base station responds to the first random access message 430 by sending a second random access message 431 (e.g. Msg 2) using PDSCH and including a random access response (RAR). The RAR may include, e.g., an identifier of the random access preamble sent by the UE, a time advance (TA), an uplink grant for the UE to transmit data, cell radio network temporary identifier (C-RNTI) or another identifier, and/or a back-off indicator. Upon receiving the second random access message 431, the UE 426 may transmit a third random access message 433 (e.g., Msg 3) to the base station 428, e.g., using PUSCH, that may include a RRC connection request, an RRC connection re-establishment request, or an RRC connection resume request, depending on the trigger for the initiating the random access procedure. The base station 428 may then complete the random access procedure by sending a fourth random access message 435 (e.g., Msg 4) to the UE 426, e.g., using PDCCH for scheduling and PDSCH for the message. The fourth random access message 435 may include a random access response message that includes timing advancement information, contention resolution information, and/or RRC connection setup information. The UE 426 may monitor for PDCCH, e.g., with the C-RNTI. If the PDCCH is successfully decoded, the UE 426 may also decode PDSCH. The UE 426 may send HARQ feedback for any data carried in the fourth random access message. If two UEs sent a same preamble at 430, both UEs may receive the RAR leading both UEs to send a third random access message 433. The base station 428 may resolve such a collision by being able to decode the third random access message from only one of the UEs and responding with a fourth random access message to that UE. The other UE, which did not receive the fourth random access message 435, may determine that random access did not succeed and may re-attempt random access. Thus, the fourth message may be referred to as a contention resolution message. The fourth random access message 435 may complete the random access procedure. Thus, the UE 426 may then transmit uplink communication and/or receive downlink communication with the base station 428 based on the second random access message 431 and/or the fourth random access message 435.

In order to reduce latency or control signaling overhead, a single round trip cycle between the UE 426 and the base station 428 may be achieved in a 2-step RACH process, as shown in the communication flow 450 in FIG. 4C. Aspects of Msg 1 and Msg 3 may be combined in a single message, e.g., which may be referred to as Msg A 440. The Msg A may include a random access preamble, and may also include a PUSCH transmission, e.g., such as data. The MsgA preambles may be separate from the four step preambles, yet may be transmitted in the same ROs as the preambles of the four step RACH procedure or may be transmitted in separate ROs. The PUSCH transmissions may be transmitted in PUSCH occasions (POs) that may span multiple symbols and PRBs. After the UE 426 transmits the Msg A 440, the UE 426 may wait for a response from the base station 428. Additionally, aspects of the Msg 2 and Msg 4 may be combined into a single message, which may be referred to as Msg B 442.

A RACH procedure (e.g., which may also be referred to as a random access procedure) may be used for acquiring a connection to a cell, as well as part of various connection mode procedures. A RACH procedure can be 4-step or 2-step, e.g., as illustrated in FIG. 4B and FIG. 4C. A RACH procedure may be based on a contention based procedure or a contention free procedure, e.g., depending on the timing advance (TA) information available. A RACH procedure may facilitate obtaining the accurate TA and/or cell random network temporary identifier (C-RNTI) for a UE to exchange connected mode communication with the network. An SSB may provide the details of the time offset at which RACH procedure can be initiated with message 1 transmission in UL, for example. Based on the message 1, which may include a Zadoff Chu sequence, and autocorrelation output, the network may estimate an adjustment to TA and inform the UE of the adjustment to the TA as part of message 2. The UE may adjust the TA as part of preparing to transmit a message. The UE may then transmit the RRC Connection Request (e.g., message 3) to the network along with a randomly generated number as temporary C-RNTI (TC-RNTI). The network may reply by sending the contention resolution message (message 4) along with TC-RNTI received in message 3. When the received message 4 TC-RNTI matches with message 3 TC-RNTI sent from the UE, the RACH procedure may be assumed to be successful and TC-RNTI may be noted as C-RNTI for further connection mode procedures. Otherwise, the UE may determine that the RACH procedure has failed. A RACH procedure may also be used for various activities, such as beam failure recovery (BFR), scheduling request (SR) failure, TA calculation during dell addition, during out of service (OOS) recovery, handover, or the like. In some aspects, a 4-step RACH may be based on CBRA and a 2-step RACH may be based on a CFRA procedure. When target cell SSB information is available from source cell, a UE may use the 2-step RACH procedure for faster acquisition as part of a CFRA procedure. In some wireless communication systems, various random access channel (RACH) parameters such as initial preamble power, quantity of retransmissions allowed, power ramp up step between retransmission, scaling factor, contention resolution timer, RACH response window, and other parameters, may be indicated by the network, e.g., as part of a configuration, and followed by the UE for RACH procedure.

In some aspects, the network may provide different RACH configurations for different types of UEs. As an example, the network may configure a RACH configuration that is dedicated for the higher capability or low mobility UE type (e.g., as a first type of UE). The dedicated RACH configuration may include at least one parameter that is different from the RACH configuration for regular UEs. In some aspects, the at least one parameter that may differ between the RACH configuration dedicated for the higher capability or low mobility UE type and the RACH configuration for regular UEs may include one or more of: a retransmission periodicity (e.g., larger or smaller for higher capability or low mobility UE type), a PRACH preamble format (e.g., longer for higher capability or low mobility UE type), a set of RACH sequences available for selection, an initial transmit power (e.g., higher for higher capability or low mobility UE type), a maximum transmit power (e.g., higher for higher capability or low mobility UE type), an initial RACH target reception power (e.g., higher for higher capability or low mobility UE type), a power ramping configuration (which may include a power ramping step (e.g., smaller for higher capability or low mobility UE type), a power ramping down step (e.g., use ramping down instead of ramping up for higher capability or low mobility UE type), or a configuration of no power ramp (e.g., no power ramp higher capability or low mobility UE type but with a high initial transmit power)), a maximum allowed quantity of retransmissions (e.g., smaller for higher capability or low mobility UE type), a scaling factor, a contention resolution timer (e.g., smaller for higher capability or low mobility UE type), a RACH response window (e.g., smaller for higher capability or low mobility UE type), a directly configured RACH transmission power (e.g., configuring RACH transmission power instead of RACH target reception power or initial transmission power for higher capability or low mobility UE type), open-loop power control parameter(s), or a set of resources for the RACH (e.g., which may differ for higher capability or low mobility UE type). In some aspects, different types of RACH parameters may be provided in the RACH configuration dedicated for the higher capability or low mobility UE type such as: (1) directly providing the UL TX power (P0), which may be the initial UL TX power (so it may ramp up or ramp down over retransmissions) or may be a fixed UL TX power (no further ramp up), (2) alpha factor for DL pathloss compensation, (3) pathloss RS that may be different than SSBs (e.g., NW may send periodic CSI-RS (e.g., with possibly narrow beam) for a higher capability or low mobility UE even when it is in idle/inactive state), or (4) power ramping that may be configured or not configured. In some aspects, for RACH configuration dedicated for the higher capability or low mobility UE type, power configuration may be provided in a per-beam basis. In some aspects, for RACH configuration dedicated for the higher capability or low mobility UE type, power configuration may be provided in a per-cell or multiple cell basis. In some aspects, for RACH configuration dedicated for the higher capability or low mobility UE type, power configuration may be provided for one or more cells.

In some aspects, by separating RACH occasions for higher capability or low mobility UEs and regular UEs, the impact of higher capability or low mobility UE on regular UEs may be reduced.

In some aspects, there may be common/shared RACH resources for different types of UEs, with a possibility of type-specific power configuration (e.g., a RACH power configuration for higher capability or low mobility UEs, a separate RACH power configuration for regular UEs).

In some aspects, the RACH configuration dedicated for the higher capability or low mobility UE type and the RACH configuration for regular UEs may be both broadcasted by the network node in SIB 1. In some aspects, RACH transmission power instead of RACH target reception power or initial transmission power may be configured for higher capability or low mobility UE type, which may be configured without signaling, configured via the SIB 1, or loaded before connection to the network. In general, more aggressive power configuration for higher capability or low mobility UEs (such as CPE devices) may be used such that their RACH may be successful in a smaller number of retransmissions.

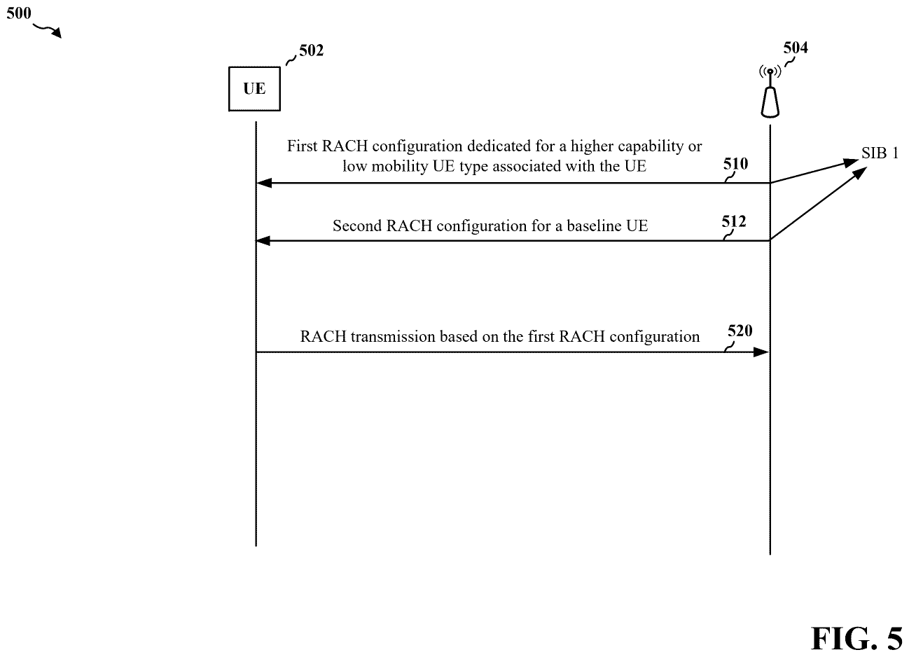

FIG. 5 is a diagram 500 illustrating example communications between a network entity 504 and a UE 502, in accordance with various aspects of the present disclosure. As illustrated in FIG. 5, the network entity 504 may broadcast, in SIB1, the first RACH configuration 510 dedicated for a higher capability or low mobility UE type associated with the UE and the second RACH configuration 520 for a baseline UE and the UE 502 may receive the SIB 1. The UE 502 may transmit, to the network node, a RACH transmission based on the first RACH configuration dedicated for the higher capability or low mobility UE type. The RACH transmission may be a RACH message in a four-step RACH procedure or a RACH message in a two-step RACH procedure.

In some aspects, instead of, or in addition to, including the RACH configuration dedicated for the higher capability or low mobility UE type in SIB 1, after the first connection, the RACH configuration dedicated for the higher capability or low mobility UE type may be provided for future RACH processes (e.g., reconnections).

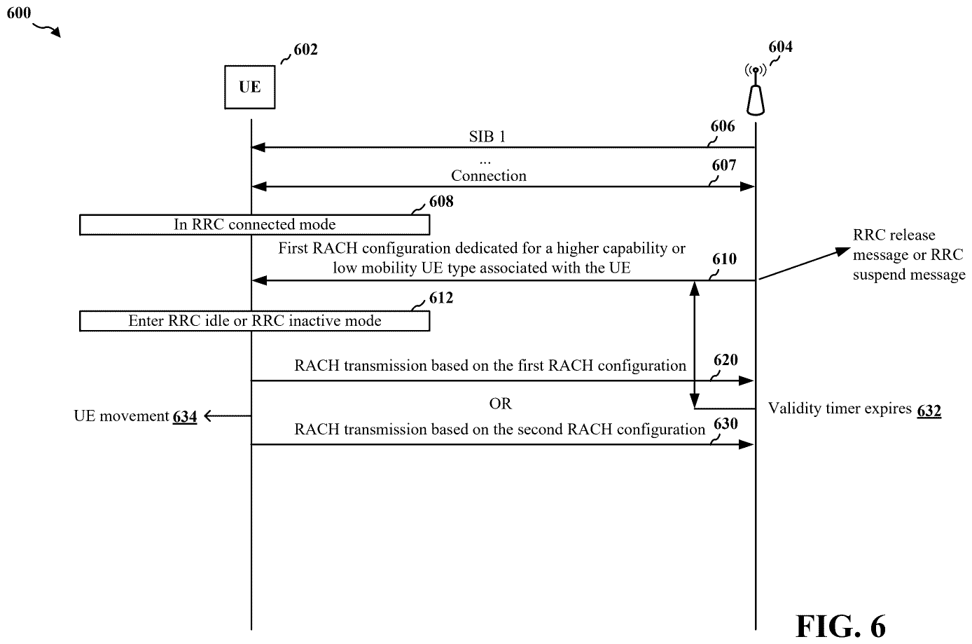

FIG. 6 is a diagram 600 illustrating example communications between a network entity 604 and a UE 602, in accordance with various aspects of the present disclosure. As illustrated in FIG. 6, the UE 602 may establish a connection with the network entity 604 at 607, which may be a RACH procedure based on the SIB 1 606. In some aspects, the SIB 1 606 may include the RACH configuration for a baseline UE and the connection may be established based on the RACH configuration for the baseline UE. In some aspects, in a RRC connected mode at 608, the UE 602 may receive the RACH configuration 610 dedicated for the higher capability or low mobility UE type so that it may be used when the UE 602 is switched to an idle/inactive state (at 612) and reconnect (or send RACH for other purposes). In some aspects, the RACH configuration 610 dedicated for the higher capability or low mobility UE type may be provided in a RRC suspend or RRC release message. Although the RACH configuration 610 is described as dedicated for the higher capability or low mobility UE type as an example, in some aspects, the RACH configuration 610 may be dedicated for a first UE type and the SIB 1 606 may be associated with a RACH configuration for a second UE type.

In some aspects, the RACH configuration 610 dedicated for the higher capability or low mobility UE type may be valid based on certain condition(s) (e.g., which may be a configured condition or a defined condition). In some aspects, the condition(s) may include: an associated validity timer (e.g., the RACH configuration 610 expires after the validity timer expires), valid for the RACH succeeding the first transition to idle/inactive state (e.g., when UE receives such indication, such as in an RRC release or RRS suspend message, the configuration may be valid for RACH until the next time that the UE connected and expires after the next connection) but not valid after subsequent transitions, valid for a cell (cell-specific) or a group of cells or area (area-specific) (e.g., the configuration is not valid for other cells if the UE performs cell reselection), based on a measurement (e.g., reference signal received power (RSRP), reference signal received quality (RSRQ), signal to interference and noise (SINR), or the like) threshold that may or may not be beam/SSB-specific or CSI-RS-specific (e.g., or delta threshold compared to a reference threshold such as last reported RSRP or RSRP associated with a last time the UE performed RACH), a threshold on the max amount of change in DL Rx timing (measured based on SSB/CSI-RS and compared to a reference DL RX timing acquired at a prior time), a movement 634 beyond a threshold distance (e.g., invalid if moved beyond the threshold distance), a cause of the RACH (e.g., based on a type of traffic and/or QoS specifications involved in the upcoming RACH, whether UE is paged or if the UE is initiating the connection for UL traffic), or when the UE/CPE is paged, paging/wake-up message may indicate whether the UE may use the dedicated RACH power configuration 610 or not. In some aspects, if a defined number (e.g., one or more) of conditions is not met, the UE may use the RACH configuration for baseline UEs configured in the SIB 606 instead of the RACH configuration 610 dedicated for the higher capability or low mobility UE type in the subsequence RACH transmission 630. In some aspects, if a defined number of conditions is met, the UE 602 may use the the RACH configuration 610 dedicated for the higher capability or low mobility UE type in the subsequence RACH transmission 620.

In some aspects, the UE may suggest at least one RACH parameter (e.g., based on its local measurements/estimations, capabilities, or the like), such as at least one RACH parameter in a RACH power configuration, and the network may configure the dedicated RACH power configuration 610 accordingly. In some aspects, the suggestion may be in terms of any of the mentioned RACH parameters. In some aspects, the suggestion may be in the form of one, multiple or a range a values for each associated parameters. In some aspects, the UE may further suggest at least one parameter for its connected state as well (e.g., for example, parameter used for UL synchronization, beam failure recovery, fallback from scheduling request maximum retransmissions, or the like).

In some aspects, the RACH configuration for baseline UEs may be in a format in which time spacing between successive power ramping may allow staying at a same power level, supports separate power for higher capability or low mobility UE type (e.g., for message A payload, message 3, and/or HARQ-ACK for message 4), support transmission power control (TPC) command MSG2 to be interpreted differently depending on the device type (e.g., the step size/interpretation of the bits to indicate TPC command may be different between baseline UEs and higher capability or low mobility UEs). In some aspects, the cell may be aware of whether the UE is a higher capability or low mobility UE or not (e.g., based on an indication in early type indication in message A payload or message 3, or via the choice of preamble ID or RO that may be dedicated for the higher capability or low mobility UE).

In some aspects, for PDCCH-order RACH (e.g. random access in response to an indication received in a PDCCH transmission), downlink control information (DCI) from the network may indicate to the UE whether to use a power configuration that is specific to higher capability or low mobility UEs (e.g., the ones that CPE used during initial access) or a normal power configuration (e.g., what normal UEs would use), e.g., that is common to other types of UEs including baseline UEs.

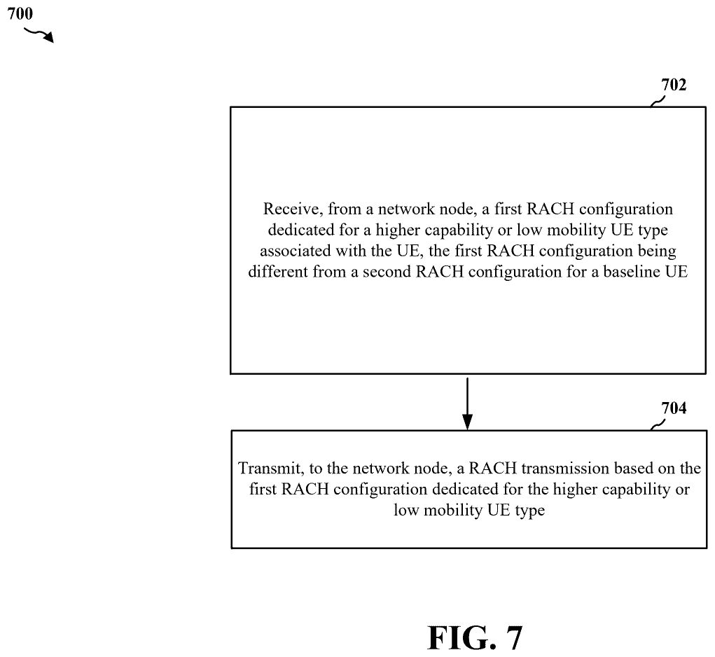

FIG. 7 is a flowchart 700 of a method of wireless communication. The method may be performed by a UE (e.g., the UE 104, the UE 502, the UE 602; the apparatus 1004). The method may provide specific random access channel (RACH) configuration(s) for CPE or FWA devices that may be different from RACH configuration(s) for baseline UEs, which may enhance efficiency (e.g., reduction of retransmissions) for CPE or FWA devices, and enhance efficiency for the wireless communication network overall (e.g., based on reduction of load at the cell).

At 702, the UE may receive, from a network node, a first RACH configuration dedicated for a higher capability or low mobility UE type associated with the UE, the first RACH configuration being different from a second RACH configuration for a baseline UE (e.g., a normal UE or a regular UE). For example, the UE (e.g., 502, 602) may receive, from a network node (e.g., 504, 604), a first RACH configuration (e.g., 510, 610) dedicated for a higher capability or low mobility UE type associated with the UE, the first RACH configuration being different from a second RACH configuration (e.g., 512, or in 606) for a baseline UE (e.g., a normal UE). In some aspects, 702 may be performed by RACH component 198. In some aspects, the first RACH configuration may be associated with a first UE type and the second RACH configuration may be associated with a second UE type.

At 704, the UE may transmit, to the network node, a RACH transmission based on the first RACH configuration dedicated for the higher capability or low mobility UE type. For example, the UE (e.g., 502, 602) may transmit, to the network node (e.g., 504, 604), a RACH transmission (e.g., 520, 620) based on the first RACH configuration dedicated for the higher capability or low mobility UE type. In some aspects, 704 may be performed by RACH component 198.

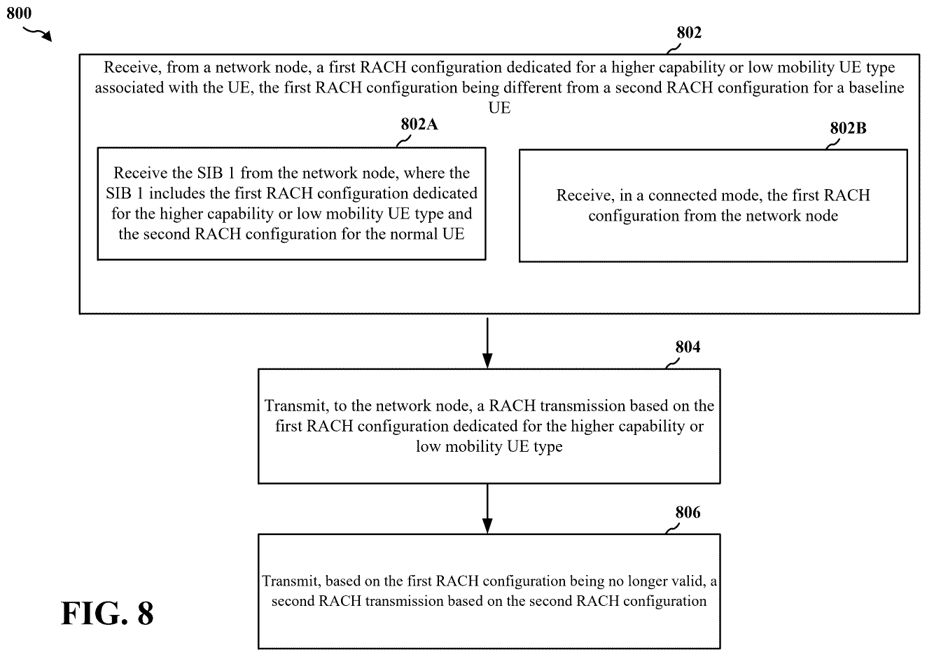

FIG. 8 is a flowchart 800 of a method of wireless communication. The method may be performed by a UE (e.g., the UE 104, the UE 502, the UE 602; the apparatus 1004). The method may provide specific random access channel (RACH) configuration(s) for CPE or FWA devices that may be different from RACH configuration(s) for baseline UEs, which may enhance efficiency (e.g., reduction of retransmissions) for CPE or FWA devices, and enhance efficiency for the wireless communication network overall (e.g., based on reduction of load at the cell).

At 802, the UE may receive, from a network node, a first RACH configuration dedicated for a higher capability or low mobility UE type associated with the UE, the first RACH configuration being different from a second RACH configuration for a baseline UE (e.g., a normal UE). For example, the UE (e.g., 502, 602) may receive, from a network node (e.g., 504, 604), a first RACH configuration (e.g., 510, 610) dedicated for a higher capability or low mobility UE type associated with the UE, the first RACH configuration being different from a second RACH configuration (e.g., 512, or in 606) for a baseline UE (e.g., a normal UE). In some aspects, 802 may be performed by RACH component 198.

In some aspects, the first RACH configuration includes a first RACH power configuration, where the second RACH configuration includes a second RACH power configuration, and where at least one parameter of the first RACH power configuration is different from the second RACH power configuration. In some aspects, the first RACH power configuration includes a first initial RACH target reception power and the second RACH power configuration includes a second RACH target reception power, the first initial RACH target reception power being higher than the second RACH target reception power. In some aspects, the first RACH power configuration includes a first power ramp step and the second RACH power configuration includes a second power ramp step, the first power ramp step being larger than the second power ramp step. In some aspects, the first RACH power configuration includes a first quantity of maximum retransmissions and the second RACH power configuration includes a second quantity of maximum retransmissions, the first quantity of maximum retransmissions being smaller than the second quantity of maximum retransmissions. In some aspects, the first RACH power configuration includes a first initial RACH target transmission power and the second RACH power configuration includes a second RACH target transmission power, the first initial RACH target transmission power being higher than the second RACH target transmission power. In some aspects, the first RACH power configuration includes a power ramp down step and the second RACH power configuration includes a power ramp up step. In some aspects, the first RACH power configuration includes a transmission power without adjustment and the second RACH power configuration includes an initial transmission power. In some aspects, the first RACH power configuration is associated with at least one particular cell or at least one particular beam associated with the network node. In some aspects, the first RACH configuration includes a first RACH resource configuration, where the second RACH configuration includes a second RACH resource configuration, and where at least one RACH resource configured by the first RACH resource configuration is same as the second RACH resource configuration.

In some aspects, the first RACH configuration dedicated for the higher capability or low mobility UE type is an initial RACH configuration in a SIB 1, and where to receive the first RACH configuration, at 802A, the UE may receive the SIB 1 from the network node, where the SIB 1 includes the first RACH configuration dedicated for the higher capability or low mobility UE type and the second RACH configuration for the baseline UE (e.g., the normal UE). In some aspects, the first RACH configuration may be associated with a first UE type and the second RACH configuration may be associated with a second UE type.

In some aspects, the first RACH configuration dedicated for the higher capability or low mobility UE type is a subsequent RACH configuration, where the RACH transmission is a RACH reconnection message, and where to receive the first RACH configuration, at 802B, the UE may receive, in a connected mode (e.g., 608), the first RACH configuration (e.g., 610) from the network node. In some aspects, the first RACH configuration is included in a RRC release message or a RRC suspend message. In some aspects, the first RACH configuration is associated with a validity timer (e.g., 632), and where the first RACH configuration is valid for a duration equal to the validity timer after a switch from the connected mode to a different mode. In some aspects, a validity of the first RACH configuration is associated with a particular cell or a particular area. In some aspects, a validity of the first RACH configuration is associated with a measurement associated with the UE being above a measurement threshold or associated with a movement associated with the UE being below a movement threshold. In some aspects, the UE may transmit, to the network node, a suggestion (e.g., before 610) of a set of parameters associated with the first RACH configuration.

At 804, the UE may transmit, to the network node, a RACH transmission based on the first RACH configuration dedicated for the higher capability or low mobility UE type. For example, the UE (e.g., 502, 602) may transmit, to the network node, a RACH transmission (e.g., 520, 620) based on the first RACH configuration dedicated for the higher capability or low mobility UE type. In some aspects, 804 may be performed by RACH component 198.

At 806, the UE may transmit, based on the first RACH configuration being no longer valid, a second RACH transmission based on the second RACH configuration. For example, the UE (e.g., 602) may transmit, based on the first RACH configuration (e.g., 610) being no longer valid, a second RACH transmission (e.g., 630) based on the second RACH configuration. In some aspects, 806 may be performed by RACH component 198.

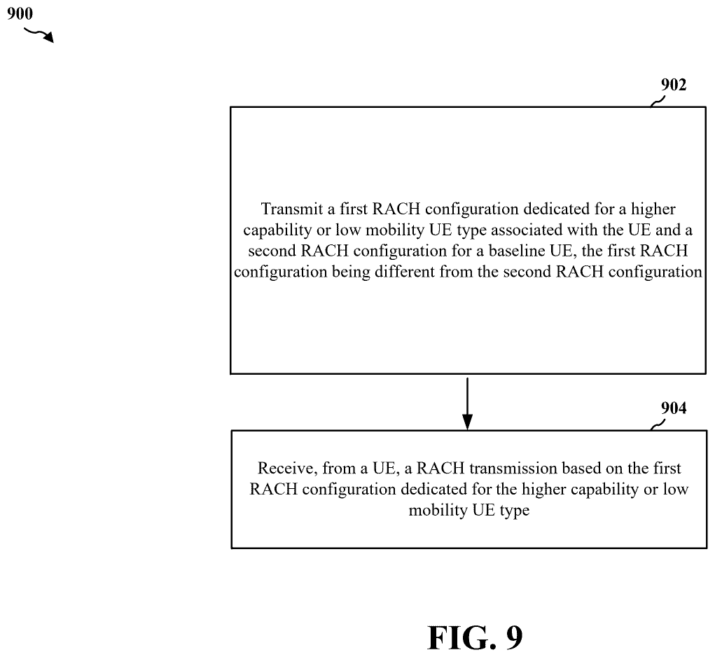

FIG. 9 is a flowchart 900 of a method of wireless communication. The method may be performed by a network entity (e.g., the base station 102, the network entity 1002, the network entity 1102). The method may provide specific random access channel (RACH) configuration(s) for CPE or FWA devices that may be different from RACH configuration(s) for regular UEs, which may enhance efficiency (e.g., reduction of retransmissions) for CPE or FWA devices, and enhance efficiency for the wireless communication network overall (e.g., based on reduction of load at the cell).

At 902, the network entity may transmit a first RACH configuration dedicated for a higher capability or low mobility UE type associated with the UE and a second RACH configuration for a baseline UE (e.g., a normal UE), the first RACH configuration being different from the second RACH configuration. For example, the network entity (e.g., 504, 604) may transmit a first RACH configuration (e.g., 510, 610) dedicated for a higher capability or low mobility UE type associated with the UE and a second RACH configuration (e.g., 512, or in 606) for a baseline UE (e.g., a normal UE), the first RACH configuration being different from the second RACH configuration. In some aspects, 902 may be performed by RACH component 199.

At 904, the network entity may receive, from a UE, a RACH transmission based on the first RACH configuration dedicated for the higher capability or low mobility UE type. For example, the network entity (e.g., 504, 604) may receive, from a UE (e.g., 502, 602), a RACH transmission (e.g., 520, 620) based on the first RACH configuration dedicated for the higher capability or low mobility UE type. In some aspects, 904 may be performed by RACH component 199.

In some aspects, the first RACH configuration includes a first RACH power configuration, where the second RACH configuration includes a second RACH power configuration, and where at least one parameter of the first RACH power configuration is different from the second RACH power configuration. In some aspects, the first RACH power configuration includes a first initial RACH target reception power and the second RACH power configuration includes a second RACH target reception power, the first initial RACH target reception power being higher than the second RACH target reception power. In some aspects, the first RACH power configuration includes a first power ramp step and the second RACH power configuration includes a second power ramp step, the first power ramp step being larger than the second power ramp step. In some aspects, the first RACH power configuration includes a first quantity of maximum retransmissions and the second RACH power configuration includes a second quantity of maximum retransmissions, the first quantity of maximum retransmissions being smaller than the second quantity of maximum retransmissions. In some aspects, the first RACH power configuration includes a first initial RACH target transmission power and the second RACH power configuration includes a second RACH target transmission power, the first initial RACH target transmission power being higher than the second RACH target transmission power. In some aspects, the first RACH power configuration includes a power ramp down step and the second RACH power configuration includes a power ramp up step. In some aspects, the first RACH power configuration includes a transmission power without adjustment and the second RACH power configuration includes an initial transmission power. In some aspects, the first RACH power configuration is associated with at least one particular cell or at least one particular beam associated with the network node. In some aspects, the first RACH configuration includes a first RACH resource configuration, where the second RACH configuration includes a second RACH resource configuration, and where at least one RACH resource configured by the first RACH resource configuration is same as the second RACH resource configuration.

In some aspects, the first RACH configuration dedicated for the higher capability or low mobility UE type is an initial RACH configuration in a SIB 1, and where to receive the first RACH configuration, at 802A, the UE may receive the SIB 1 from the network node, where the SIB 1 includes the first RACH configuration dedicated for the higher capability or low mobility UE type and the second RACH configuration for the baseline UE (e.g., a normal UE).

In some aspects, the first RACH configuration dedicated for the higher capability or low mobility UE type is a subsequent RACH configuration, where the RACH transmission is a RACH reconnection message, and where to receive the first RACH configuration, at 802B, the UE may receive, in a connected mode, the first RACH configuration from the network node. In some aspects, the first RACH configuration is included in a RRC release message or a RRC suspend message. In some aspects, the first RACH configuration is associated with a validity timer, and where the first RACH configuration is valid for a duration equal to the validity timer after a switch from the connected mode to a different mode. In some aspects, a validity of the first RACH configuration is associated with a particular cell or a particular area. In some aspects, a validity of the first RACH configuration is associated with a measurement associated with the UE being above a measurement threshold or associated with a movement associated with the UE being below a movement threshold. In some aspects, the UE may transmit, to the network node, a suggestion of a set of parameters associated with the first RACH configuration.

In some aspects, the first RACH configuration includes a first RACH power configuration, where the second RACH configuration includes a second RACH power configuration, and where at least one parameter of the first RACH power configuration is different from the second RACH power configuration. In some aspects, the first RACH power configuration includes a first initial RACH target reception power and the second RACH power configuration includes a second RACH target reception power, the first initial RACH target reception power being higher than the second RACH target reception power. In some aspects, the first RACH power configuration includes a first power ramp step and the second RACH power configuration includes a second power ramp step, the first power ramp step being larger than the second power ramp step. In some aspects, the first RACH power configuration includes a first quantity of maximum retransmissions and the second RACH power configuration includes a second quantity of maximum retransmissions, the first quantity of maximum retransmissions being smaller than the second quantity of maximum retransmissions. In some aspects, the first RACH power configuration includes a first initial RACH target transmission power and the second RACH power configuration includes a second RACH target transmission power, the first initial RACH target transmission power being higher than the second RACH target transmission power. In some aspects, the first RACH power configuration includes a power ramp down step and the second RACH power configuration includes a power ramp up step. In some aspects, the first RACH power configuration includes a transmission power without adjustment and the second RACH power configuration includes an initial transmission power. In some aspects, the first RACH power configuration is associated with at least one particular cell or at least one particular beam associated with the network node. In some aspects, the first RACH configuration includes a first RACH resource configuration, where the second RACH configuration includes a second RACH resource configuration, and where at least one RACH resource configured by the first RACH resource configuration is same as the second RACH resource configuration.

In some aspects, the first RACH configuration dedicated for the higher capability or low mobility UE type is an initial RACH configuration in a SIB 1, and where to transmit the first RACH configuration, the UE may receive the SIB 1 from the network node, where the SIB 1 includes the first RACH configuration dedicated for the higher capability or low mobility UE type and the second RACH configuration for the baseline UE (e.g., a normal UE).

In some aspects, the first RACH configuration dedicated for the higher capability or low mobility UE type is a subsequent RACH configuration, where the RACH transmission is a RACH reconnection message, and where to receive the first RACH configuration, at 802B, the UE may receive, in a connected mode, the first RACH configuration from the network node. In some aspects, the first RACH configuration is included in a RRC release message or a RRC suspend message. In some aspects, the first RACH configuration is associated with a validity timer, and where the first RACH configuration is valid for a duration equal to the validity timer after a switch from the connected mode to a different mode. In some aspects, a validity of the first RACH configuration is associated with a particular cell or a particular area. In some aspects, a validity of the first RACH configuration is associated with a measurement associated with the UE being above a measurement threshold or associated with a movement associated with the UE being below a movement threshold. In some aspects, the UE may transmit, to the network node, a suggestion of a set of parameters associated with the first RACH configuration.

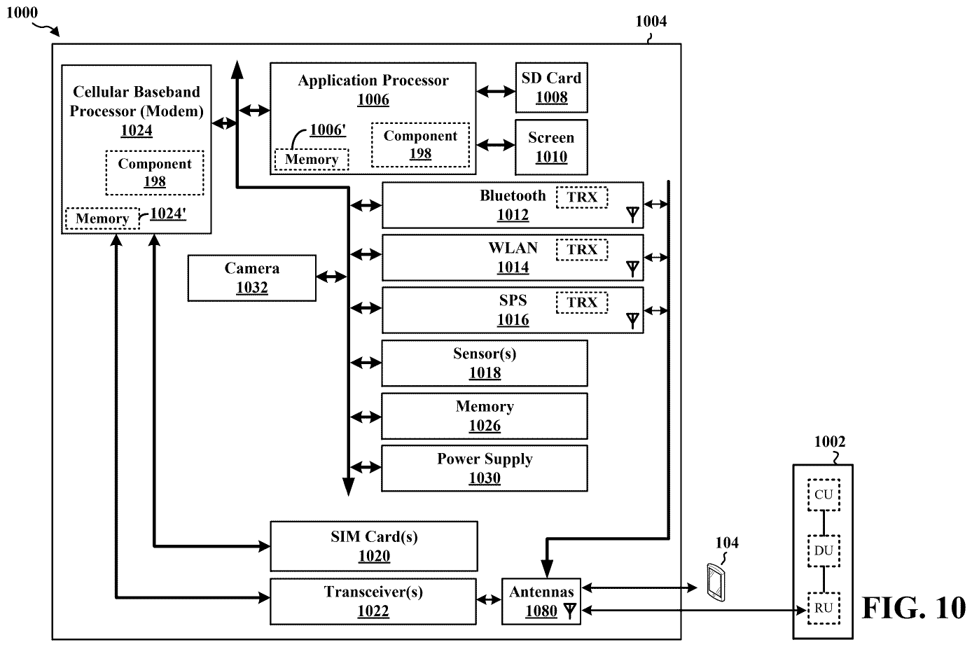

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the RACH component 198 may be configured to receive, from a network node, a first RACH configuration dedicated for a higher capability or low mobility UE type associated with the UE, the first RACH configuration being different from a second RACH configuration for a baseline UE (e.g., which may be referred to as a normal UE). In some aspects, the RACH component 198 may be further configured to transmit, to the network node, a RACH transmission based on the first RACH configuration dedicated for the higher capability or low mobility UE type. The RACH component may be further configured to perform any of the aspects described in connection with flowchart in FIG. 7 and/or FIG. 8, and/or any of the aspects performed by the UE in the communication flow in FIGS. 5 and/or 6. The RACH component 198 may be within the cellular baseband processor(s) 1024, the application processor(s) 1006, or both the cellular baseband processor(s) 1024 and the application processor(s) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for receiving, from a network node, a first RACH configuration dedicated for a higher capability or low mobility UE type associated with the UE, the first RACH configuration being different from a second RACH configuration for a baseline UE (e.g., which may be referred to as a normal UE). In some aspects, the apparatus 1004 may include means for transmitting, to the network node, a RACH transmission based on the first RACH configuration dedicated for the higher capability or low mobility UE type. In some aspects, the apparatus 1004 may include means for receiving the SIB 1 from the network node, where the SIB 1 includes the first RACH configuration dedicated for the higher capability or low mobility UE type and the second RACH configuration for the baseline UE (e.g., the normal UE). In some aspects, the apparatus 1004 may include means for receiving, in a connected mode, the first RACH configuration from the network node. In some aspects, the apparatus 1004 may include means for transmitting, based on the first RACH configuration being no longer valid, a second RACH transmission based on the second RACH configuration. In some aspects, the apparatus 1004 may include means for transmitting, to the network node, a suggestion of a set of parameters associated with the first RACH configuration. The apparatus 1004 may further include means for performing any of the aspects described in connection with flowchart in FIG. 7 and/or FIG. 8, and/or any of the aspects performed by the UE in the communication flow in FIGS. 5 and/or 6. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

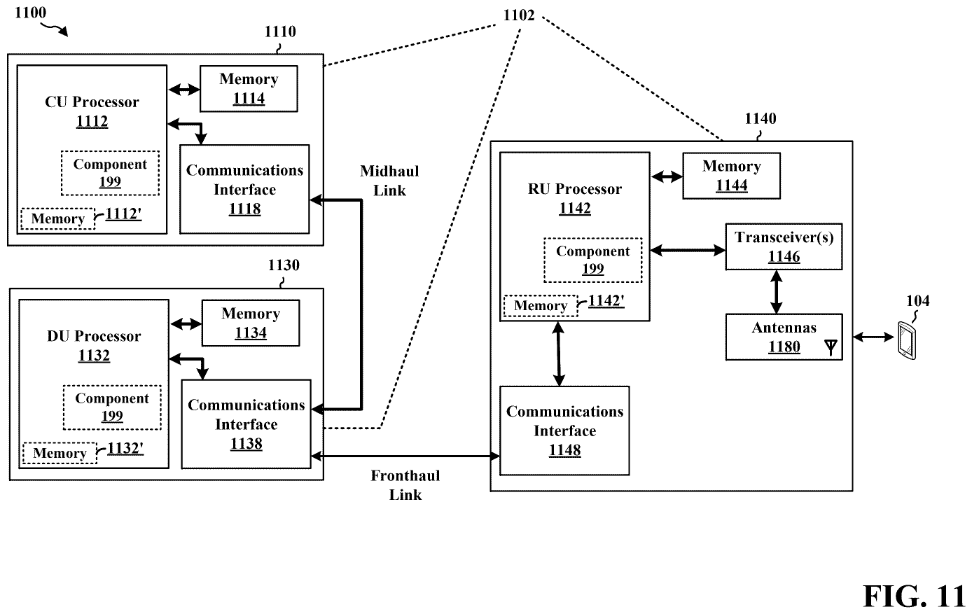

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the RACH component 199 may be configured to transmit a first RACH configuration dedicated for a higher capability or low mobility UE type associated with the UE and a second RACH configuration for a baseline UE (e.g., which may be referred to as a normal UE), the first RACH configuration being different from the second RACH configuration. In some aspects, the RACH component 199 may be further configured to receive, from a UE, a RACH transmission based on the first RACH configuration dedicated for the higher capability or low mobility UE type. The RACH component 199 may be further configured to perform any of the aspects described in connection with flowchart in FIG. 9, and/or any of the aspects performed by the network node in the communication flow in FIGS. 5 and/or 6. The RACH component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 may include means for transmitting a first RACH configuration dedicated for a higher capability or low mobility UE type associated with the UE and a second RACH configuration for a baseline UE (e.g., which may be referred to as a normal UE), the first RACH configuration being different from the second RACH configuration. In some aspects, the network entity 1102 may include means for receiving, from a UE, a RACH transmission based on the first RACH configuration dedicated for the higher capability or low mobility UE type. In some aspects, the network entity 1102 may include means for transmitting the SIB 1, where the SIB 1 includes the first RACH configuration dedicated for the higher capability or low mobility UE type and the second RACH configuration for the baseline UE (e.g., normal UE). In some aspects, the network entity 1102 may include means for transmitting, while the UE is in a connected mode, the first RACH configuration. In some aspects, the network entity 1102 may include means for receiving, from the UE, a second RACH transmission based on the second RACH configuration. The network entity 1102 may further include means for performing any of the aspects described in connection with flowchart in FIG. 9, and/or any of the aspects performed by the network node in the communication flow in FIGS. 5 and/or 6. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, based at least in part on information stored in the at least one memory, the at least one processor is configured to: receive, from a network node, a first random access channel (RACH) configuration dedicated for a higher capability or a low mobility UE type associated with the UE, the first RACH configuration being different from a second RACH configuration for a baseline UE; and transmit, to the network node, a RACH transmission based on the first RACH configuration dedicated for the higher capability or the low mobility UE type.

Aspect 2 is the apparatus of aspect 1, where the first RACH configuration includes a first RACH power configuration, where the second RACH configuration includes a second RACH power configuration, and where at least one parameter of the first RACH power configuration is different from the second RACH power configuration.

Aspect 3 is the apparatus of aspect 2, where the first RACH power configuration includes a first initial RACH target reception power and the second RACH power configuration includes a second RACH target reception power, the first initial RACH target reception power being higher than the second RACH target reception power.

Aspect 4 is the apparatus of any of aspects 2-3, where the first RACH power configuration includes a first power ramp step and the second RACH power configuration includes a second power ramp step, the first power ramp step being larger than the second power ramp step.

Aspect 5 is the apparatus of any of aspects 2-4, where the first RACH power configuration includes a first quantity of maximum retransmissions and the second RACH power configuration includes a second quantity of maximum retransmissions, the first quantity of maximum retransmissions being smaller than the second quantity of maximum retransmissions.

Aspect 6 is the apparatus of any of aspects 2-5, where the first RACH power configuration includes a first initial RACH target transmission power and the second RACH power configuration includes a second RACH target transmission power, the first initial RACH target transmission power being higher than the second RACH target transmission power.

Aspect 7 is the apparatus of any of aspects 2-6, where the first RACH power configuration includes a power ramp down step and the second RACH power configuration includes a power ramp up step.

Aspect 8 is the apparatus of any of aspects 2-7, where the first RACH power configuration includes a transmission power without adjustment and the second RACH power configuration includes an initial transmission power.

Aspect 9 is the apparatus of any of aspects 2-8, where the first RACH power configuration is associated with at least one particular cell or at least one particular beam associated with the network node.

Aspect 10 is the apparatus of any of aspects 1-9, where the first RACH configuration includes a first RACH resource configuration, where the second RACH configuration includes a second RACH resource configuration, and where at least one RACH resource configured by the first RACH resource configuration is same as the second RACH resource configuration.

Aspect 11 is the apparatus of any of aspects 1-10, where the first RACH configuration dedicated for the higher capability or the low mobility UE type is an initial RACH configuration in a system information block 1 (SIB 1), and where to receive the first RACH configuration, the at least one processor is configured to: receive the SIB 1 from the network node, where the SIB 1 includes the first RACH configuration dedicated for the higher capability or the low mobility UE type and the second RACH configuration for the baseline UE.

Aspect 12 is the apparatus of any of aspects 1-11, where the first RACH configuration dedicated for the higher capability or the low mobility UE type is a subsequent RACH configuration, where the RACH transmission is a RACH reconnection message, and where to receive the first RACH configuration, the at least one processor is configured to: receive, in a connected mode, the first RACH configuration from the network node.

Aspect 13 is the apparatus of aspect 12, where the first RACH configuration is included in a radio resource control (RRC) release message or a RRC suspend message.

Aspect 14 is the apparatus of any of aspects 12-13, where the first RACH configuration is associated with a validity timer, and where the first RACH configuration is valid for a duration equal to the validity timer after a switch from the connected mode to a different mode.

Aspect 15 is the apparatus of any of aspects 12-14, where a validity of the first RACH configuration is associated with a particular cell or a particular area.

Aspect 16 is the apparatus of any of aspects 12-15, where a validity of the first RACH configuration is associated with a measurement associated with the UE being above a measurement threshold or associated with a movement associated with the UE being below a movement threshold.

Aspect 17 is the apparatus of any of aspects 12-16, where the at least one processor is configured to: transmit, based on the first RACH configuration being no longer valid, a second RACH transmission based on the second RACH configuration.

Aspect 18 is the apparatus of any of aspects 12-17, where the at least one processor is configured to: transmit, to the network node, a suggestion of a set of parameters associated with the first RACH configuration.

Aspect 19 is an apparatus for wireless communication at a network node, including: at least one memory; and at least one processor coupled to the at least one memory, based at least in part on information stored in the at least one memory, the at least one processor is configured to: transmit a first random access channel (RACH) configuration dedicated for a higher capability or a low mobility UE type associated with the UE and a second RACH configuration for a baseline UE, the first RACH configuration being different from the second RACH configuration; and receive, from a user equipment (UE), a RACH transmission based on the first RACH configuration dedicated for the higher capability or the low mobility UE type.

Aspect 20 is the apparatus of aspect 19, where the first RACH configuration includes a first RACH power configuration, where the second RACH configuration includes a second RACH power configuration, and where at least one parameter of the first RACH power configuration is different from the second RACH power configuration.

Aspect 21 is the apparatus of aspect 20, where the first RACH power configuration includes a first initial RACH target reception power and the second RACH power configuration includes a second RACH target reception power, the first initial RACH target reception power being higher than the second RACH target reception power.

Aspect 22 is the apparatus of any of aspects 20-21, where the first RACH power configuration includes a first power ramp step and the second RACH power configuration includes a second power ramp step, the first power ramp step being larger than the second power ramp step.

Aspect 23 is the apparatus of any of aspects 20-22, where the first RACH power configuration includes a first quantity of maximum retransmissions and the second RACH power configuration includes a second quantity of maximum retransmissions, the first quantity of maximum retransmissions being smaller than the second quantity of maximum retransmissions.

Aspect 24 is the apparatus of any of aspects 20-23, where the first RACH power configuration includes a first initial RACH target transmission power and the second RACH power configuration includes a second RACH target transmission power, the first initial RACH target transmission power being higher than the second RACH target transmission power.

Aspect 25 is the apparatus of any of aspects 20-24, where the first RACH power configuration includes a power ramp down step and the second RACH power configuration includes a power ramp up step.

Aspect 26 is the apparatus of any of aspects 20-25, where the first RACH power configuration includes a transmission power without adjustment and the second RACH power configuration includes an initial transmission power.

Aspect 27 is the apparatus of any of aspects 20-26, where the first RACH power configuration is associated with at least one particular cell or at least one particular beam associated with the network node.

Aspect 28 is the apparatus of any of aspects 19-27, where the first RACH configuration includes a first RACH resource configuration, where the second RACH configuration includes a second RACH resource configuration, and where at least one RACH resource configured by the first RACH resource configuration is same as the second RACH resource configuration.

Aspect 29 is the apparatus of any of aspects 19-28, where the first RACH configuration dedicated for the higher capability or the low mobility UE type is an initial RACH configuration in a system information block 1 (SIB 1), and where to transmit the first RACH configuration, the at least one processor is configured to: transmit the SIB 1 to the UE, where the SIB 1 includes the first RACH configuration dedicated for the higher capability or the low mobility UE type and the second RACH configuration for the baseline UE.

Aspect 30 is the apparatus of any of aspects 19-29, where the first RACH configuration dedicated for the higher capability or the low mobility UE type is a subsequent RACH configuration, where the RACH transmission is a RACH reconnection message, and where to transmit the first RACH configuration, the at least one processor is configured to: transmit, while the UE is in a connected mode, the first RACH configuration.

Aspect 31 is the apparatus of aspect 30, where the first RACH configuration is included in a radio resource control (RRC) release message or a RRC suspend message.

Aspect 32 is the apparatus of any of aspects 30-31, where the first RACH configuration is associated with a validity timer, and where the first RACH configuration is valid for a duration equal to the validity timer after a switch from the connected mode to a different mode.

Aspect 33 is the apparatus of any of aspects 30-32, where a validity of the first RACH configuration is associated with a particular cell or a particular area.

Aspect 34 is the apparatus of any of aspects 30-33, where a validity of the first RACH configuration is associated with a measurement associated with the UE being above a measurement threshold or associated with a movement associated with the UE being below a movement threshold.

Aspect 35 is the apparatus of any of aspects 30-34, where the at least one processor is configured to: receive a second RACH transmission based on the second RACH configuration.

Aspect 36 is the apparatus of any of aspects 30-35, where the at least one processor is configured to: receive a suggestion of a set of parameters associated with the first RACH configuration.

Aspect 37 is a method of wireless communication for implementing any of aspects 1 to 18.

Aspect 38 is a computer-readable medium (e.g., a non-transitory computer-readable medium) storing computer executable code, the code when executed by at least one processor causes the at least one processor to implement any of aspects 1 to 18.

Aspect 39 is an apparatus comprising means for implementing any of aspects 1 to 18.

Aspect 40 is a method of wireless communication for implementing any of aspects 19 to 36.

Aspect 41 is a computer-readable medium (e.g., a non-transitory computer-readable medium) storing computer executable code, the code when executed by at least one processor causes the at least one processor to implement any of aspects 19 to 36.

Aspect 42 is an apparatus comprising means for implementing any of aspects 19 to 36.

What is claimed is:

1. An apparatus for wireless communication at a user equipment (UE), comprising:
at least one memory; and
at least one processor coupled to the at least one memory, based at least in part on information stored in the at least one memory, the at least one processor is configured to:
receive, from a network node, a first random access channel (RACH) configuration dedicated for a higher capability or a low mobility UE type associated with the UE, the first RACH configuration being different from a second RACH configuration for a baseline UE; and
transmit, to the network node, a RACH transmission based on the first RACH configuration dedicated for the higher capability or the low mobility UE type.

2. The apparatus of claim 1, wherein the first RACH configuration comprises a first RACH power configuration, wherein the second RACH configuration comprises a second RACH power configuration, and wherein at least one parameter of the first RACH power configuration is different from the second RACH power configuration.

3. The apparatus of claim 2, wherein the first RACH power configuration comprises a first initial RACH target reception power and the second RACH power configuration comprises a second RACH target reception power, the first initial RACH target reception power being higher than the second RACH target reception power.

4. The apparatus of claim 2, wherein the first RACH power configuration comprises a first power ramp step and the second RACH power configuration comprises a second power ramp step, the first power ramp step being larger than the second power ramp step.

5. The apparatus of claim 2, wherein the first RACH power configuration comprises a first quantity of maximum retransmissions and the second RACH power configuration comprises a second quantity of maximum retransmissions, the first quantity of maximum retransmissions being smaller than the second quantity of maximum retransmissions.

6. The apparatus of claim 2, wherein the first RACH power configuration comprises a first initial RACH target transmission power and the second RACH power configuration comprises a second RACH target transmission power, the first initial RACH target transmission power being higher than the second RACH target transmission power.

7. The apparatus of claim 2, wherein the first RACH power configuration comprises a power ramp down step and the second RACH power configuration comprises a power ramp up step.

8. The apparatus of claim 2, wherein the first RACH power configuration comprises a transmission power without adjustment and the second RACH power configuration comprises an initial transmission power.

9. The apparatus of claim 2, wherein the first RACH power configuration is associated with at least one particular cell or at least one particular beam associated with the network node.

10. The apparatus of claim 1, wherein the first RACH configuration comprises a first RACH resource configuration, wherein the second RACH configuration comprises a second RACH resource configuration, and wherein at least one RACH resource configured by the first RACH resource configuration is same as the second RACH resource configuration.

11. The apparatus of claim 1, wherein the first RACH configuration dedicated for the higher capability or the low mobility UE type is an initial RACH configuration in a system information block 1 (SIB 1), and wherein to receive the first RACH configuration, the at least one processor is configured to:
receive the SIB 1 from the network node, wherein the SIB 1 comprises the first RACH configuration dedicated for the higher capability or the low mobility UE type and the second RACH configuration for the baseline UE.

12. The apparatus of claim 1, wherein the first RACH configuration dedicated for the higher capability or the low mobility UE type is a subsequent RACH configuration, wherein the RACH transmission is a RACH reconnection message, and wherein to receive the first RACH configuration, the at least one processor is configured to:
receive, in a connected mode, the first RACH configuration from the network node.

13. The apparatus of claim 12, wherein the first RACH configuration is included in a radio resource control (RRC) release message or a RRC suspend message.

14. The apparatus of claim 12, wherein the first RACH configuration is associated with a validity timer, and wherein the first RACH configuration is valid for a duration equal to the validity timer after a switch from the connected mode to a different mode.

15. The apparatus of claim 12, wherein a validity of the first RACH configuration is associated with a particular cell or a particular area.

16. The apparatus of claim 12, wherein a validity of the first RACH configuration is associated with a measurement associated with the UE being above a measurement threshold or associated with a movement associated with the UE being below a movement threshold.

17. The apparatus of claim 12, wherein the at least one processor is configured to:
transmit, based on the first RACH configuration being no longer valid, a second RACH transmission based on the second RACH configuration.

18. The apparatus of claim 12, wherein the at least one processor is configured to:
transmit, to the network node, a suggestion of a set of parameters associated with the first RACH configuration.

19. An apparatus for wireless communication at a network node, comprising:
at least one memory; and
at least one processor coupled to the at least one memory, based at least in part on information stored in the at least one memory, the at least one processor is configured to:
transmit a first random access channel (RACH) configuration dedicated for a higher capability or a low mobility UE type associated with the UE and a second RACH configuration for a baseline UE, the first RACH configuration being different from the second RACH configuration; and
receive, from a user equipment (UE), a RACH transmission based on the first RACH configuration dedicated for the higher capability or the low mobility UE type.

20. A method for wireless communication performed by a user equipment (UE), comprising:
receiving, from a network node, a first random access channel (RACH) configuration dedicated for a higher capability or a low mobility UE type associated with the UE, the first RACH configuration being different from a second RACH configuration for a baseline UE; and
transmitting, to the network node, a RACH transmission based on the first RACH configuration dedicated for the higher capability or the low mobility UE type.
